(19) United States
(12) Patent Application Publication
(10) Pub. No.: US 2007/0113604 A1
(43) Pub. Date: May 24, 2007

(54) Steering lock device

(76) Inventors: Joseph E. Khoury, Gensingen (DE); Roland Ruegenberg, Bad Sobernheim (DE); Vladimir Karasik, Oakland, MI (US); Mike Shahan, Allen Park, MI (US)

Correspondence Address: BLANK ROME LLP, 600 NEW HAMPSHIRE AVENUE, N.W., WASHINGTON, DC, 20037, US

(21) Appl. No.: 10/515,435

(22) PCT Filed: May 23, 2003
(86) PCT No.: PCT/US03/16455

§ 371 Date: Jan. 9, 2007

Related U.S. Application Data
(60) Provisional application No. 60/382,350, filed on May 23, 2002.

(51) Int. Cl. B60R 25/02

(52) U.S. Cl. 70/186

(57) ABSTRACT

A lock bolt is engages with a recess formed on the surface of the steering shaft. In a locked position, the lock bolt engages the recess of the steering shaft. In an unlocked position, the lock bolt is withdrawn and disengaged from the recess. When the ignition key is turned to start the automobile, the lock bolt disengages the steering shaft. When the ignition key is turned to stop the automobile engine from idling, the lock bolt engages the steering shaft.

### BACKGROUND OF THE INVENTION

1. Field of the Invention

The present invention relates to locking devices used in automotive applications. The invention more particularly concerns the locking of a steering shaft to a steering column of an automobile so as to prevent rotation of the steering shaft during selected periods of time. Thus, the locking device can be used as a safety device and an anti-theft device.

2. Description of the Prior Art

For years now, automobile manufacturers have been including, as a standard feature, the feature of an immobilized steering shaft when the ignition key is not inserted into the ignition switch. The immobilized steering shaft prevents the steering wheel from rotating, thus, someone not having the ignition key can not steer the car if the car is hot-wired or if someone attempts to push the car away. The theft deterrent function works so well that people who attempt to take a car without using a key, typically, employ a large screwdriver-type of device inserted into the opening for the ignition key to break, cut open, and remove the ignition device that immobilizes the steering shaft. Thus, in a single act of violence, the person breaking into the vehicle can disable both the ignition function and the steering immobilization function. Once the person has successfully removed the device, the vehicle can then be easily hot-wired and driven away. A device that integrates the two functions is disclosed in U.S. Pat. No. 5,848,540.

Attempts have been made to separate the ignition function and the anti-rotation of the steering wheel function to complicate the act of automobile theft. The person attempting to steal an automobile would need to disengage the anti-rotation device and the ignition switch separately, which consumes much more time and makes it more likely that the person will be caught in the act. As such, it is presumed that a person inclined to steal the automobile of another person will not do so since the risk is not worth the effort. An example of a device that focuses on one of the functions, the anti-rotation function, is disclosed in U.S. Pat. No. 5,896,765, and European Patent Application No. EP 764566A1. However, highly motivated car thieves may take their chances and attempt to steal an automobile incorporating the steering wheel locking devices disclosed in U.S. Pat. No. 5,896,765. The car thief would find that the locking element is one large piece of material. The car thief can beat or impact on it with push loads and either bend it, locally bend the steering shaft, or break the housing around the locking element, thus disarming the locking function.

An added benefit of placing the ignition switch in another location such as the dashboard is that the steering column area is made less busy for the driver of the vehicle. This is important because, currently, the steering column area is very busy, since it incorporates controls for directional indicators, head lamps, cruise control, windshield wipers, and etc.

Thus, there is a need for a steering lock device which is separate from the ignition switch and which prevents the destruction of the locking element when a thief attempts to disengage the steering lock device.

### SUMMARY AND OBJECTS OF THE INVENTION

An object of the invention is to provide a device which decreases the probability that a thief will be able to steer the wheel of a hot-wired automobile. Another object of the invention is to provide a steering lock device that separates the ignition function from the anti-rotation function.

Disclosed are four independent design features that decrease the probability that a thief will be able to steer the wheel of a hot-wired automobile. The first feature of the invention includes a steering lock device that separates the ignition function from the anti-rotation function.

The second feature is a safety system which includes a clutch mechanism and a lock bolt drive system that provides a lock bolt that can be engaged/disengaged with the steering shaft when the ignition key is turned to start or stop the automobile.

The third feature is the use of a protective shield as part of the lock device case. This feature makes any thief intervention from the outside very difficult.

The fourth feature is a safety system that locks the locking bolt if the metal case is broken or if any key mechanical component inside becomes loose.

In the present invention, the lock bolt is engageable with a recess formed on the surface of the steering shaft. In a locked position, the lock bolt engages the recess of the steering shaft. In an unlocked position, the lock bolt is withdrawn and disengaged from the recess. When the ignition key is turned to start the automobile, the lock bolt disengages the steering shaft. When the ignition key is turned to stop the automobile engine from idling, the lock bolt engages the steering shaft.

Thus, the invention achieves the objectives set forth above. The invention provides a device which is physically separate from the ignition function and which increases the effort required to steal an automobile equipped with the steering lock device. Additionally, the device fits within existing real estate on the steering column and has few moving parts which are inexpensive to produce and assemble. Therefore, even in the most violent of environments, the steering lock device will perform as intended and deter the theft of the vehicle.

### BRIEF DESCRIPTION OF THE DRAWINGS

The preferred embodiments of this invention will be described in detail, with reference to the following figures, wherein:

FIG. 1 illustrates a first embodiment of the steering lock device of the present invention;

FIG. 2 illustrates the steering lock device of FIG. 1 mounted on a shaft;

FIG. 3 illustrates a clutch device wheel and a contact according to the first embodiment of the present invention;

FIG. 4 illustrates a retainer assembly according to the first embodiment of the present invention;

FIG. 5 illustrates a bottom view of the retainer assembly of FIG. 5;

FIG. 6 illustrates the steering lock device in a lock position;

FIG. 7 illustrates the steering lock device in an unlock position;

FIG. 8 illustrates a second embodiment of the steering lock device of the present invention;

FIG. 9 illustrates the steering lock device of FIG. 8 mounted on a shaft; and

FIG. 10 illustrates a third embodiment of the steering lock device of the present invention.

### DETAILED DESCRIPTION OF THE PREFERRED EMBODIMENTS

The present invention includes a locking device for locking a steering shaft to a steering column to prevent rotation of the steering shaft during a period of time. The locking device may be used as a safety and anti-theft device for automobiles.

The present invention provides a steering lock device that separates the ignition function from the anti-rotation function. A clutch mechanism and a lock bolt drive system provide a lock bolt that can be engaged/disengaged with the steering shaft when the ignition key is turned to start or stop the automobile. A metal case covering the lock mechanism makes any thief intervention from outside very difficult.

The system of the present invention locks the locking bolt if the metal case is broken or any key mechanical component inside becomes loose.

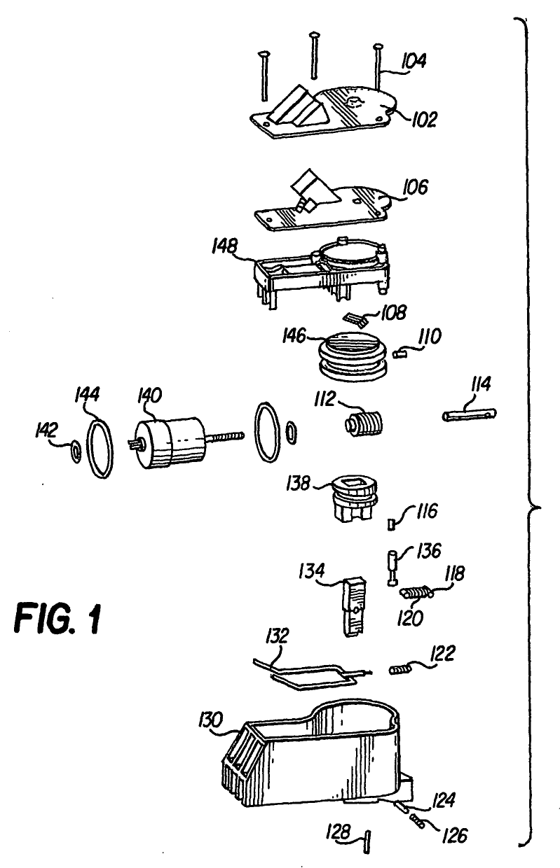

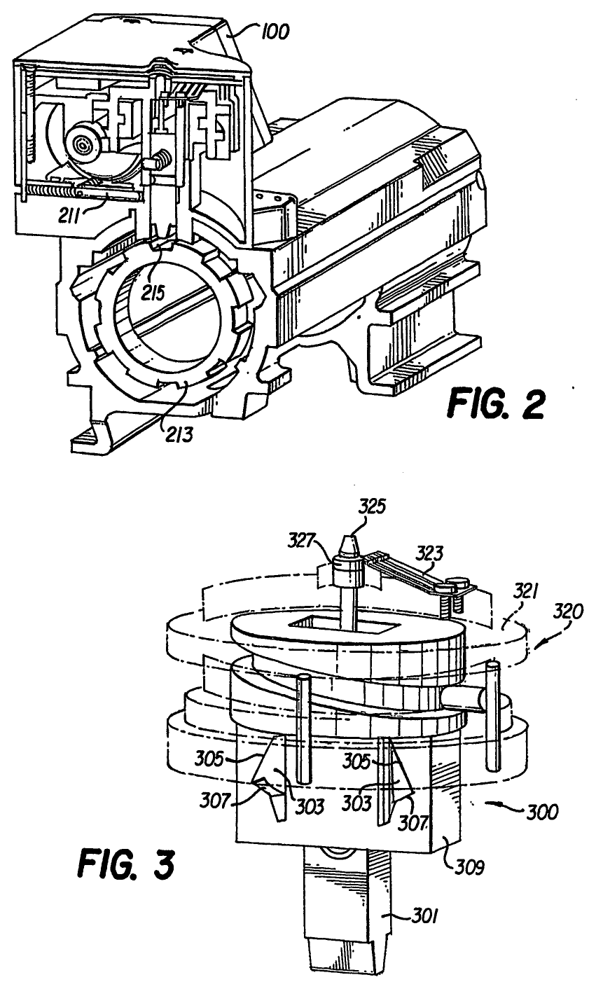

Referring now to the drawings, wherein like reference numerals designate identical or corresponding parts throughout the several views, and more particularly to FIGS. 1-2 thereof, an embodiment of the present invention is a steering lock device with safety system 100 as shown in FIG. 1 as an exploded perspective view.

The steering lock device includes a lock bolt 134; a clutch mechanism (and clutch housing 138) with spring loaded rollers (combination of 118 and 120); a worm wheel 146; a contact/sensing system for lock bolt position detection (not shown); a PCB assembly 106 with a connector; an electric motor 140 with the worm 112 connected to the motor shaft; a motor shock absorption system (not shown); security pins 124 and springs; a PCB, motor, and lock bolt clutch mechanism retainer 148; and a cover 102 and housing 130.

In the system of FIG. 1, a unique clutch mechanism is incorporated with the lock bolt 134. The clutch mechanism includes a set of spring loaded rollers (118 and 120) located between the clutch detent profiles. These provide free bolt movement to lock and unlock positions. Any misalignment between the bolt and the recess (not shown) formed on the surface of the steering shaft (when the bolt moves to a lock position) and the bolt stall condition (when the bolt is withdrawn from the recess) is compensated by the rollers 118 movement along the clutch detent profiles.

The bolt drive mechanism includes a clutch housing 138, worm wheel 146 and driving pin 110. The clutch housing 138 has a closed spiral groove tilted at 10 degrees which may provide 4.5 mm bolt travel reciprocally, with one directional motor. The motor worm meshed with the drive wheel provides a 50:1 ratio.

A description of the operation of the system of FIG. 1 follows. FIG. 1 illustrates a motor 140 having a worm 112. The worm 112 is the rotational output of the motor 140. The worm 112 meshes with a worm wheel 146. The worm wheel 146 is rotatably mounted in a retainer 148. A large O-ring 144 and a small O-ring 142 attach to the motor 140. A printed circuit board (PCB) 106 is situated between the retainer 148 and a cover 102. The PCB 106 contains the logic which controls the motor 140. Attached to the lock bolt 134 is the lock bolt return spring 122. Screws 104 align the cover 102 with the housing 130. The sliding contact 108 is electrically connected to the PCB 106.

In operation in one state, the lock bolt 134 engages a recess on the surface of the steering shaft (not shown). The lock bolt return springs 122 is in a compressed state. A lock bolt contact (not shown) is attached to the housing 130 and sends an electrical signal to the PCB 106 when the lock bolt 134 is in the engaged position. The lock bolt contact sends and electrical signal to the PCB 106 when the lock bolt 134 is in the engaged or locked position since the lock bolt 134 touches the lock bolt contact. Likewise, when the lock bolt 134 is withdrawn from the recess, the lock bolt contact alters the signal sent to the PCB 106, thus indicating that the lock bolt 134 is not fully engaged with the recess of the steering shaft.

When the ignition key is introduced into the ignition and is rotated, the ignition switch sends an electrical signal to the PCB 106. The PCB 106 sends a signal to the motor 140, the motor 140 rotates the worm 112, and the worm 112 rotates the worm wheel 146. The lock bolt 134 is fully removable from the recess in the surface of the steering shaft thus allowing the steering shaft to rotate.

When the ignition key is rotated so as to be removed from the ignition switch, the ignition switch sends a signal to the PCB 106. The PCB 106 sends a signal to the motor 140. The motor 140 rotates the worm 112. The worm 112 rotates the worm wheel 146. The lock bolt 134 engages the recess on the surface of the steering shaft thus locking up the steering shaft. At this position, the motor 140 stops turning.

Other elements included in FIG. 1 as part of the lock bolt mechanism are the sleeve 114, magnet 116, rolled pin 128, fork 132, and actuator 136.

FIG. 2 illustrates the steering lock device of FIG. 1 assembled in a retainer and mounted on a shaft 213. The device 100 is shown in an unlock position. FIG. 2 shows a security pin 211 which moves inside the lock bolt if the device housing is damaged. The figure also shows a recess area 215 on the shaft's collar.

FIG. 3 illustrates a clutch mechanism 300 that may be used in the embodiment of FIG. 1. The clutch mechanism 300, incorporated with the lock bolt 301, has a set of spring loaded rollers 303 located between the clutch detent profiles 305, 307. The clutch mechanism 300 provides free bolt movement to lock and unlock positions. Any misalignment between the bolt 301 and the recess 215 formed on the surface of the steering shaft makes the bolt stall. The motor continued rotation will be compensated by the rollers movement along the clutch detent profiles.

If the lock bolt 301 is not aligned with the shaft recess 215 (moving to lock position) the lock bolt 301 is pushed up against the steering shaft. The motor would continue to attempt rotation and moves the clutch housing 309 toward the steering shaft recess 215 while the clutch rollers 303 slide along the top detent profiles 305, compressing the clutch spring. Once the steering shaft is slightly rotated so that the recess 215 aligns the lock bolt 301, the steering shaft will pop into the recess 215 due to the force supplied by the overly compressed clutch spring.

When the lock bolt 301 is stalled into the recess during the unlock position, the motor moves the clutch housing 309 up and pushes the rollers towards each other along the lower clutch housing detent profiles 307. The spring compression force is enough to overcome the friction between the lock bolt 301 and the recess 215.

The bolt drive mechanism of the present invention may include a clutch assembly, drive wheel with driving pin, motor and gear train. In addition to the clutch assembly 300, FIG. 3 illustrates a drive wheel mechanism 320.

The clutch housing 309 has a closed spiral groove tilted at 10 degrees from the horizontal plane. The drive wheel 321 is located over this area such that a metal pin is inserted into the grove. When the drive wheel 321 rotates (the part may have one degree of freedom), the pin slides along the groove and pushes the clutch assembly 300 to move up or down depending on the groove current position. The 10 degree groove plane may reciprocally provide 4.5 mm of bolt travel.

The motor operates at high speed and provides low torque. The gear ratio through the worm and worm gear is very large and outputs low speed and high torque. The large torque is converted into a force at the interface between the drive pin and clutch groove. The force is large enough to overcome the force produced by the rollers compressing the clutch spring due to any misalignment. The motor worm meshed with the drive wheel 321 may provide a 50:1 ratio.

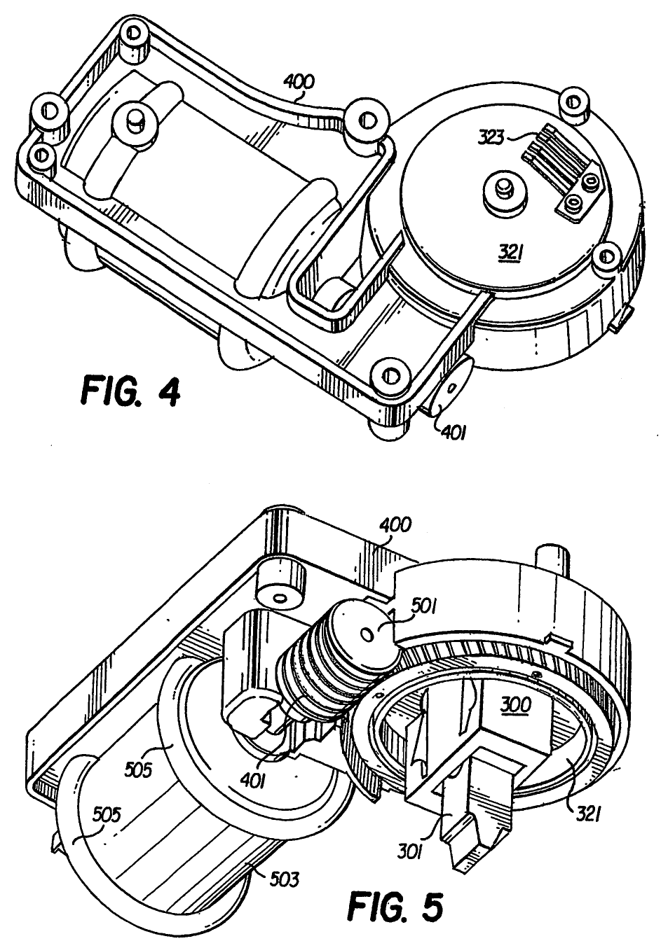

FIG. 3 also illustrates a sensing system for bolt position detection. A contact 323 is attached to the drive wheel 321 to detect the lock bolt 301 position. The contact 323 sends an electrical signal to a PCB (not shown) when the lock bolt 301 is in either the lock or unlock position. When the ignition key is in and is rotated, the ignition switch (not shown) sends an electrical signal to the PCB. The PCB sends a signal to motor, which rotates the worm 401 (see FIG. 4). The worm 401 rotates the worm gear, which activates the clutch mechanism 300 with the bolt 301. The device stays in this position while the engine of the vehicle is operating, i.e., the ignition key is in the ignition and has been rotated so as to start the vehicle. The logic in the PCB signals the battery to stop sending power to the motor. When the ignition key is rotated so as to be removed from the ignition switch, the ignition switch sends a signal to the PCB which causes the bolt 301 to become engaged with the steering shaft recess 215. The locking bolt state is detected also by a magnet 327 on the actuator 325 located on the clutch assembly 300.

FIG. 4 illustrates the clutch assembly 300 in a retainer 400. FIG. 5 illustrates a bottom view of the retainer assembly 400. FIG. 5 illustrates the clutch assembly 300; drive wheel 321; lock bolt 301; worm wheel 501; worm 401; motor 503; and O-rings 505.

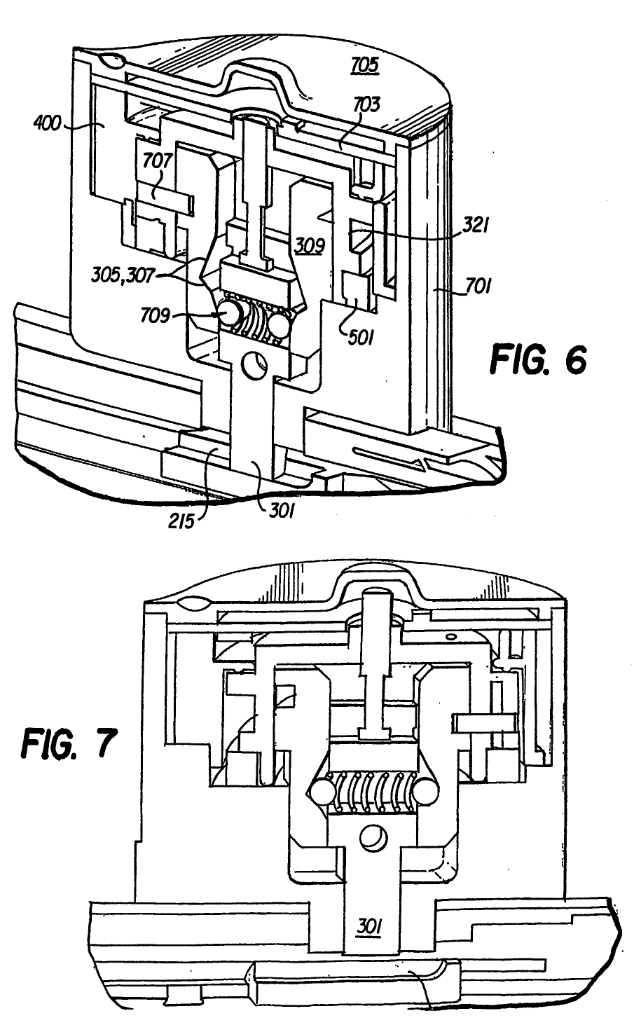

FIG. 6 illustrates the steering lock device of the present invention in a lock position. FIG. 6 illustrates a device cover 705; a PCB 703; drive wheel 321; a device housing 701; clutch housing 309; worm wheel 501; a rollers-spring assembly 709; detent profiles 305, 307; the retainer 400; and the drive pin 707. Most importantly, FIG. 6 illustrates the bolt 301 in the lock position (engaging the recess area 215 of the shaft), thus blocking the shaft.

FIG. 7 illustrates the steering lock device in the unlock position according to one embodiment of the present invention. The figure shows that the bolt 301 does not engage the shaft recess 215. The shaft is then free to rotate.

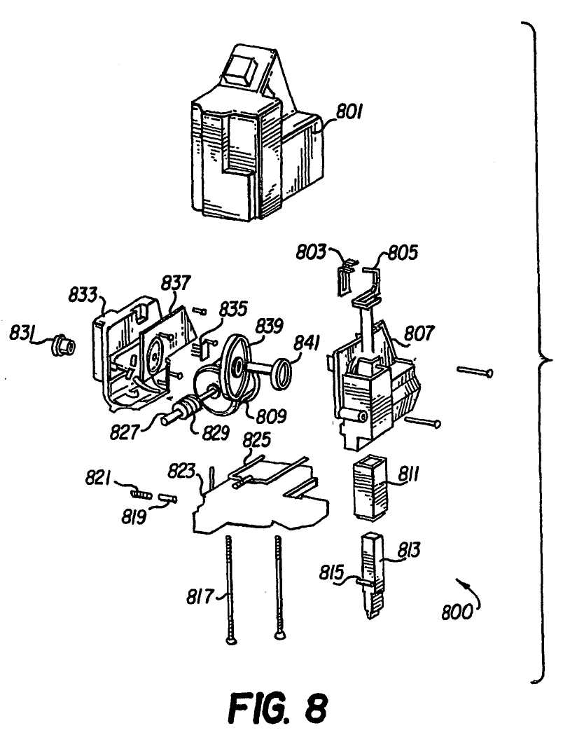

FIG. 8 illustrates a second embodiment 800 of the steering lock device of the present invention. The steering lock device may include a housing 801; contact carrier 803; contact carrier driver 805; a retainer with right (807) and left (833) sides; motor 809; clutch housing 811; lock bolt 813; clutch roller 815; screws 817; locking pin 819; spring 821; base 823; fork 825; worm shaft 827; worm 829; bushing 831; contact 835; PCB 837; drive wheel 839; and eccentric 841.

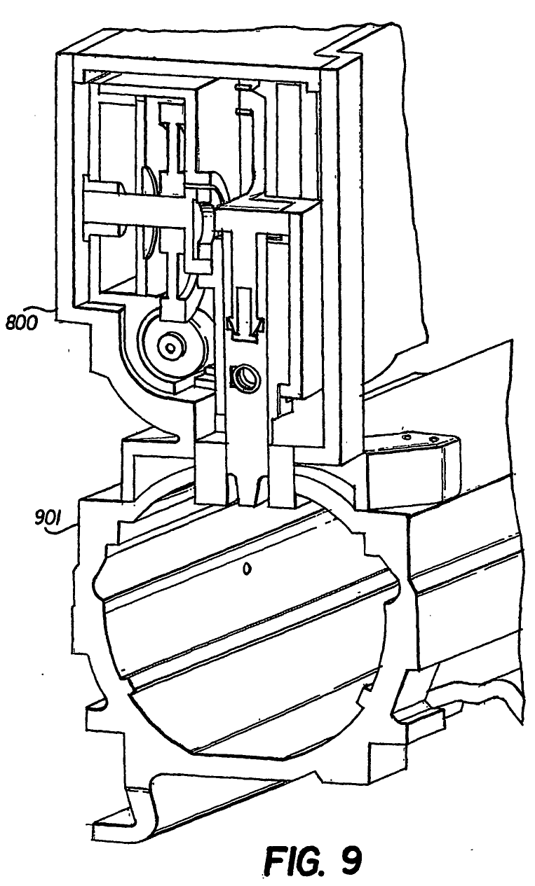

The main difference between the steering lock device 800 and the device 100 is the bolt drive mechanism. The bolt drive mechanism of the device 800 may be based on an eccentrically located round shape cam 841 that engages with clutch pins. The cam may be positioned at 90 degrees from the bolt movement direction, which may require different packaging and different parts design from the device 100. The eccentrically located cam 841 may have a 4.5 mm offset to provide the corresponding lock bolt movement. Other major components in the device 800 function similar to those in the device 100, but may have a different shape. FIG. 9 illustrates the steering lock device 800 mounted on a shaft 901.

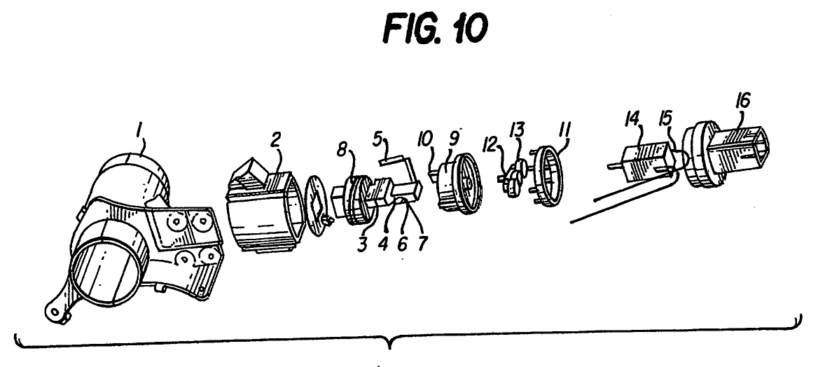

FIG. 10 illustrates a third embodiment of the steering lock device of the present invention. The third embodiment may include a lock housing 1; a base 2; lock bolt 3; lock bolt carrier 4; contact spring bolt 5; roller 6; spring 7; clutch 8; rotor 9; contact spring clutch 10; belt 11; yoke 12; roller 13; motor 14; cable 15; and housing 16.

The third embodiment mainly differs from the first and second embodiments in that it uses a different gear train to activate the clutch mechanism. The hypocycloid gear reduction mechanism includes the motor 14, belt 11, yoke 12 and roller 13. The motor shaft may be attached to the center roller 13 which is in mesh with the yoke 12 (two planetary gears). The yoke 12 activates an outside gear which is attached to a drive wheel. This gear train produces a large reduction ratio, offers low sliding, high stress loading and long life.

The disclosed designs have very low noise and relatively low friction because the drive systems exert a low force and the motor is isolated from the metal housing.

While this invention has been described in conjunction with the specific embodiments outlined above, it is evident that many alternatives, modifications and variations are apparent to those skilled in the art. Accordingly, the preferred embodiments of the invention as set forth above are intended to be illustrative and not limiting. Various changes may be made without departing from the spirit and scope of the invention.

What is claimed is:

1. A steering lock device comprising:
a lock bolt;
a bolt drive mechanism; and
a clutch mechanism having spring loaded rollers.

2. A steering lock device according to claim 1, wherein the spring loaded rollers are located between clutch detent profiles.

3. A steering lock device according to claim 1, further comprising a lock bolt position detector.

4. A steering lock device according to claim 3, further comprising a PCB assembly that is electrically connected to the position detector.

5. A steering lock device according to claim 2, wherein the spring loaded rollers move along the clutch detent profiles to compensate for any misalignment between the bolt and a recess of a steering shaft.

6. A steering lock device according to claim 1, further comprising a motor and a worm connected to an output shaft of the motor.

7. A steering lock device according to claim 6, further comprising a worm wheel meshed with the worm.

8. A steering lock device according to claim 7, wherein a gear ratio at the mesh between the worm wheel and the worm is greater than fifty to one, so that the worm wheel rotates once for every fifty revolutions of the worm.

9. A steering lock device according to claim 1, wherein the bolt drive mechanism includes a clutch housing, the worm wheel, and a driving pin.

10. A steering lock device according to claim 9, wherein the clutch housing includes a closed spiral groove.
